(19) United States
(12) Patent Application Publication
(10) Pub. No.: US 2015/0168359 A1
(43) Pub. Date: Jun. 18, 2015

(54) DERIVATIZATION REACTION GAS CHROMATOGRAPHIC CHIP

(71) Applicant: Korea Basic Science Institute, Daejeon (KR)

(72) Inventors: Sanggoo KIM, Seoul (KR); Sung-Min LIM, Seoul (KR)

(73) Assignee: Korea Basic Science Institute, Daejeon (KR)

(21) Appl. No.: 14/132,108

(22) Filed: Dec. 18, 2013

(30) Foreign Application Priority Data
Dec. 18, 2013 (KR) 10-2013-0158130

(51) Int. Cl. G01N 30/60

(52) U.S. Cl. CPC G01N 30/6095

(57) ABSTRACT

Provided is a derivatization reaction gas chromatographic chip including: an analysis solution inlet allowing an analysis solution containing an analysis target to be introduced therethrough; a derivative inlet allowing a reaction solution containing a derivative chemically reacting with the analysis target to be introduced therethrough; a guide channel connecting one end of a first micro-channel to each of the analysis solution inlet and the derivative inlet; the first micro-channel in which a fluid flows and the analysis target in the fluid is vaporized; a first outlet connected to the other end of the first micro-channel; a gas phase inlet communicating with the first outlet; a second micro-channel having one end connected to the gas phase inlet and having a stationary phase formed therein; and a second outlet connected to the other end of the second micro-channel.

### CROSS-REFERENCE TO RELATED APPLICATIONS

This application claims priority under 35 U.S.C. §119 to Korean Patent Application No. 10-2013-0158130, filed on Dec. 18, 2013, in the Korean Intellectual Property Office, the disclosure of which is incorporated herein by reference in its entirety.

### TECHNICAL FIELD

The following disclosure relates to a derivatization reaction gas chromatographic chip, and more particularly, to a derivatization reaction gas chromatographic chip capable of performing a derivatization reaction and a gas chromatography analysis on an analysis target, as a single micro-chip.

### BACKGROUND

In general, chromatography refers to an analysis method. According to this method, various solids or liquids standing in a stationary phase and gases or liquids standing in a mobile (or moving) phase are adopted and, while the gases or liquids in the moving phase are allowed to pass through the solids or liquids in the stationary phase, samples are put into the gases or liquids in the mobile phase so as to be separated by components thereof based on differences in adsorbability or partition coefficients of the samples between the gases or liquids in the mobile phase and the solids or liquids in the stationary phase.

Materials in use include (1) gases, (2) chemical materials, (3) biological materials, e.g., DNA, carbohydrate, lipid, peptide, protein, or any combination thereof, (4) molecules, or (5) a certain combination of the foregoing materials, but the present inventive concept is not limited thereto. Materials separated by using chromatography may be analyzed by using various detecting units that may be attached to a device. So far, multiple types of chromatography and separation mechanism have been provided and used for inspection positively.

Various types of chromatography have been developed and used for extensive analysis including separation of a natural substance, refinement of medicine, refinement of any other chemical materials, and the like.

Chromatography may be divided in to gas chromatography using a gas in a mobile phase and a liquid chromatography using a liquid in a mobile phase according to types of mobile phases. Liquid chromatography under the name of high pressure liquid chromatography (HPLC) (or high performance liquid chromatography), assorted according to pressure applied to a mobile phase, has been commercially developed and placed on the market.

Also, thin layer chromatography in which a glass plate or a synthetic resin plate is coated with silica gel powder, and the like, has also been frequently used for a simple analysis, and ion exchange chromatography which performs separation and analysis using ionic bond between ions, instead of using a difference between partition coefficients (or distribution coefficients), and the like, has also been developed and used.

In spite of the development and commercial supply of various types of chromatography, these types of chromatography are fundamentally merely based on separation using physical properties of samples desired to be analyzed thereby, namely, a partition coefficient, a molecular mass, ionicity, and the like, between a stationary phase and a mobile phase. Thus, optimal separation and analysis conditions of a desired sample may be determined by interactions between various analysis factors such as selection of a stationary phase or a mobile phase, a flow rate of a mobile phase, a temperature at which distribution occurs, selection of a detector that detects a separated and eluted sample, and the like, according to a target sample, rather than being defined or determined. Here, determination of analysis factors in an analysis device may be critical as affecting analysis results, and thus, analyzers need to select an optimal analysis device based on chromatography all the time.

In particular, in comparison to liquid chromatography such as HPLC, or the like, gas chromatography has a high degree of precision and sensitivity, is easy in maintenance and repair, supports simple facilities, being advantageous especially for a basic analysis and a periodical analysis which is repeatedly performed commonly, and thus, it is widely used.

However, since a mobile phase is a gas, materials having a low degree of volatility cannot be analyzed with gas chromatography. In order to solve this problem, Korean Patent No. 1004749 presented a technique of increasing volatility and enhancing sensitivity and accuracy of analysis through a derivatization reaction.

However, such a derivation reaction is independently performed as a pre-processing process before a gas chromatography analysis, requiring equipment therefor, and in order to obtain reproductive and precise results, the derivatization reaction process needs to be performed by an expert, increasing analysis cost and analysis complexity.

### RELATED ART DOCUMENT

### Patent Document

Korean Patent No. 1004749

### SUMMARY

An embodiment of the present invention is directed to providing a gas chromatographic chip capable of performing a derivatization reaction and a gas chromatography analysis on an analysis target, as a single micro-chip.

In one general aspect, a derivatization reaction gas chromatographic chip may include: an analysis solution inlet allowing an analysis solution containing an analysis target to be introduced therethrough; a derivative inlet allowing a reaction solution containing a derivative chemically reacting with the analysis target to be introduced therethrough; a guide channel connecting one end of a first micro-channel to each of the analysis solution inlet and the derivative inlet; the first micro-channel in which a fluid introduced through the analysis solution inlet and the derivative inlet flows and the analysis target in the fluid reacting with the derivative is vaporized; a first outlet connected to the other end of the first micro-channel; a gas phase inlet communicating with the first outlet; a second micro-channel having one end connected to the gas phase inlet and having a stationary phase formed therein; and a second outlet connected to the other end of the second micro-channel, wherein the analysis target contained in the analysis solution is vaporized and the vaporized analysis target is separated by the stationary phase by the single chip body.

The guide channel and the first micro-channel may be formed as a first base and a second base each having a first micro-pattern intagliated on a surface thereof are laminated and combined, the second micro-channel may be formed as a third base and a fourth base each having a second micro-pattern intagliated on a surface thereof are laminated and combined, the analysis solution inlet and the derivative inlet may be through holes penetrating through the first base, respectively, the first outlet and the gas phase inlet that communicate with one another may be a through hole of the second base and a through hole of the third base, respectively, that communicate with one another, the second outlet may be a through hole that penetrates through the fourth base or all of the third base, the second base, and the first base, and the chip body may include a laminate body formed by laminating and combining the first base, the second base, the third base, and the fourth base.

One or more reactive regions having a cross-section greater than that of the first micro-channel to form a velocity of flow lower than that of a fluid in the first micro-channel may be formed on a flow path of the first micro-channel.

Thermal energy, optical energy, or vibrational energy may be applied to the first micro-channel.

The derivatization reaction gas chromatographic chip may further include a thermoelectric element applying thermal energy to the first micro-channel.

A dry region for removing a liquid phase contained in the fluid discharged through the first outlet may be further formed in the other end of the first micro-channel in contact with the first outlet.

The derivatization reaction gas chromatographic chip may further include a modulator formed in the gas phase inlet side.

The modulator may communicate with the gas phase inlet to intermittently supply alternately a cooled inert gas and a heated inert gas to the gas phase inlet to alternately generate cryogenic traps and heat pulses.

The second micro-channel may be elongated as the amount of bases having the micro-patterns intagliated thereon and laminated below the fourth base is increased, and the elongated second micro-channel may be formed as the micro-patterns on the two surfaces of the bases forming the elongated second micro-channel in contact are combined.

The second micro-channel may have two or more different stationary phases formed in different regions thereof.

A stationary phase coating layer may be formed on all of the surfaces of the third base and the fourth base each having the second micro-pattern intagliated thereon, and faying surfaces of the third base and the fourth base may be hermetically combined by the stationary phase coating layer.

The derivatization reaction gas chromatographic chip may further include: a heat transmission unit adjusting a temperature of the second micro-channel.

Each of the base materials constituting the laminate body may be one or two or more selected from among polymethylsiloxane, polydimethylsiloxane, glass, quartz, silicon, silicate, borosilicate, and molten silicate, independently.

The micro-patterns of the respective bases constituting the laminate body may be formed through wet etching.

### BRIEF DESCRIPTION OF THE DRAWINGS

FIG. 1 is an exploded perspective view illustrating an example of a chip body of a derivatization reaction gas chromatographic chip according to an exemplary embodiment of the present invention.

FIG. 2 is an exploded perspective view illustrating another example of a chip body of a derivatization reaction gas chromatographic chip according to an exemplary embodiment of the present invention.

FIG. 3 is an exploded perspective view illustrating another example of a chip body of a derivatization reaction gas chromatographic chip according to an exemplary embodiment of the present invention.

FIG. 4 is a transmission perspective view illustrating an example of a derivative region in the derivatization reaction gas chromatographic chip according to an exemplary embodiment of the present invention.

FIG. 5 is a transmission perspective view illustrating another example of a derivative region in the derivatization reaction gas chromatographic chip according to an exemplary embodiment of the present invention.

FIG. 6 is a perspective view of the derivatization reaction gas chromatographic chip according to an exemplary embodiment of the present invention.

FIG. 7 is a perspective view illustrating an example of a chip body of the derivatization reaction gas chromatographic chip according to an exemplary embodiment of the present invention.

### DETAILED DESCRIPTION OF EMBODIMENTS

Hereinafter, a derivatization reaction gas chromatographic chip according to the present invention will be described in detail with reference to the accompanying drawings. The drawings below are provided by way of example so that the idea of the present invention can be sufficiently transported to those skilled in the art. Therefore, the present invention is not limited to the drawings to be provided below, but may be modified in many different forms. In addition, the drawings to be provided below may be exaggerated in order to clarify the scope of the present invention. Here, technical terms and scientific terms used in the present specification have the general meaning understood by those skilled in the art to which the present invention pertains unless otherwise defined, and a description for the known function and configuration obscuring the present invention will be omitted in the following description and the accompanying drawings.

In describing the present invention, chromatography refers to physical separation of a single component from an analysis target material as a material to be analyzed by using a difference in its affinity to a mobile phase and a stationary phase. Here, chromatography using a gas in a mobile phase may be generally referred to as gas chromatography, and chromatography using a liquid in a mobile phase may be generally referred to as liquid chromatography. The gas chromatography may include a liquid phase and a solid phase as a stationary phase.

The derivatization reaction gas chromatographic chip according to an exemplary embodiment of the present invention may have a single chip body including: an analysis solution inlet allowing an analysis solution containing an analysis target to be introduced therethrough; a derivative inlet allowing a reaction solution containing a derivative chemically reacting to the analysis target to be introduced therethrough; a guide channel connecting each of the analysis solution inlet and the derivative inlet to one end of a first micro-channel; the first micro-channel allowing a fluid introduced to the analysis solution inlet and the derivative inlet to flow therethrough and allowing an analysis target reacting to the derivative in the fluid (hereinafter, referred to as a ‘derivatized analysis target’) to be vaporized therein; a first outlet connected to the other end of the first micro-channel; a gas phase inlet communicating with the first outlet; a second micro-channel having one end connected to the gas phase inlet and having a stationary phase formed therein; and a second outlet connected to the other end of the second micro-channel. By the single chip body, the analysis target contained in the analysis solution may be vaporized and the vaporized analysis target may be separated by a stationary phase.

As mentioned above, in the derivatization reaction gas chromatographic chip according to an exemplary embodiment of the present invention, the analysis target hard for a gas chromatography analysis is derivatized and vaporized by the first micro-channel through which the analysis target and the derivative are introduced, and the gas chromatography analysis is performed on the derivatized analysis target by columns of the second micro-channel having a stationary phase formed therein. Thus, both the derivatization and the material analysis of the analysis target may be performed in a single stage in the single chip body.

In detail, liquid chromatography is advantageous in that it can analysis most materials, but is disadvantageous in that it has low sensitivity and is sensitive to a temperature, leading to low reproducibility and reliability, and also disadvantageous in that measurement equipment is severely contaminated and is not easy for a mobile design based on an analysis target. In comparison to liquid chromatography, gas chromatography is simple, available for analysis within a very short time, highly sensitive, and thermally stable. Namely, gas chromatography is an excellent, precise, and convenient analysis method, relative to liquid chromatography, but has shortcomings in that it can analyze only a material having good volatility. Thus, making use of the foregoing advantages such as stability, reproducibility, promptness, analysis sensitivity, and the like, of gas chromatography over liquid chromatography, a technique of derivatizing materials not easily analyzed, such as a material having low volatility (non-volatile material), a material chemically unstable under analyzing conditions, and the like, and analyzing the same through gas chromatography has been developed. It is known that derivatization of an analysis target material by reacting it with a derivative may change non-volatile materials into volatile materials, enhance separability of gas chromatogram, facilitate qualitative analysis of a compound, and enhance sensitivity.

However, a derivatization reaction is performed by a separate device and a separate process, apart from a device for a chromatography analysis, under controlled conditions such as a temperature, moisture, and the like, increasing analysis complexity, analysis cost, and an analysis time, and in case of a derivative material sensitive to moisture, a derivatization reaction should be performed within a dry box, inevitably causing a problem of spatial restriction. In addition, in case of a derivative material having toxicity, a high degree of detection and management facilities are required for a derivatization reaction in terms of safety.

In the derivatization reaction gas chromatographic chip according to an exemplary embodiment of the present invention, a derivatization reaction and gas chromatography are performed in the single chip body to analyze an analysis target, which is hard to be analyzed with gas chromatography through a single step of simply injecting an analysis target material and a derivative material. In addition, the analysis may be made within a short time at low cost, a size of the chip can be reduced, and the derivation reaction performed within an airtight space is free from a problem of safety or stability.

In the derivatization reaction gas chromatographic chip according to an exemplary embodiment of the present invention, when a region in which the first micro-channel is present and a derivation reaction is made as described above will be referred to as a derivatization region and a region in which the second micro-channel is present and an analysis target material of a mobile phase is separated by a stationary phase will be referred to as a GC region, the derivatization region may be positioned above the GC region, or conversely, the derivatization region may be positioned below the GC region.

Hereinafter, the derivatization reaction gas chromatographic chip according to an exemplary embodiment of the present invention will be described in detail on the basis of the structure in which the derivatization region is positioned above the GC region, but, of course, the same or similar concept may be maintained even in the structure in which the derivatization region is positioned below the GC region.

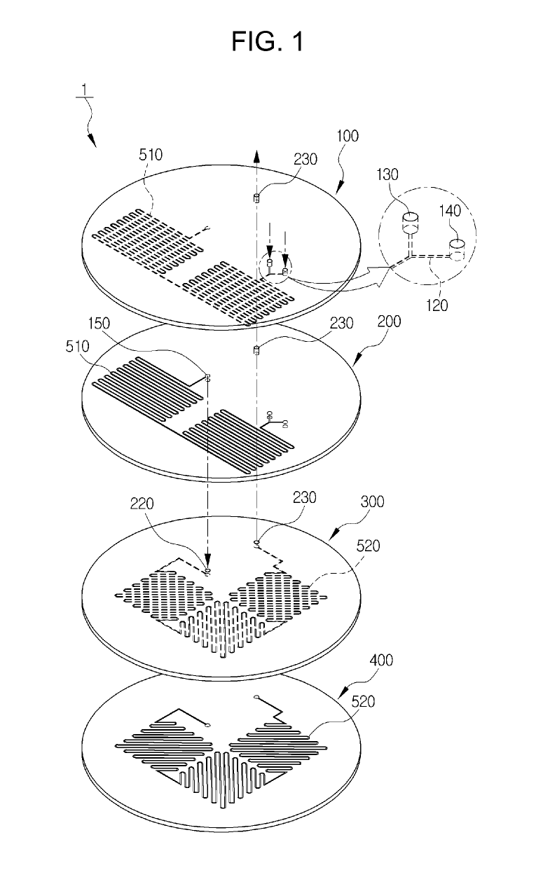

FIG. 1 is an exploded perspective view illustrating an example of a chip body of a derivatization reaction gas chromatographic chip according to an exemplary embodiment of the present invention.

As illustrated in the example of FIG. 1, a chip body may include a laminate body 1 formed by laminating and combining bases including a first base 100, a second base 200, a third base 300, and a fourth base 400. A first micro-pattern 510 as an intagliated pattern may be formed on each of surfaces of the first base 100 and the second base 200 opposing one another, and as the first base 100 and the second base 200 are laminated and combined, the first micro-pattern 510 on the surface of the first base 100 and the first micro-pattern 510 on the surface of the second base 200 may be combined to form a micro-structure including a guide channel 120 and a first micro-channel 110.

Here, when the first base 100 and the second base 200 are arranged such that the surfaces each with the intagliated first micro-pattern 510 formed thereon face in the same direction, the intagliated patterns formed on the surfaces of the first base 100 and the second base 200 may have a mirror-symmetrical structure, and when the first base 100 and the second base 200 are arranged such that the surfaces each with the intagliated pattern formed thereon face each other, the intagliated patterns formed on the surfaces of the first base 100 and the second base 200 may be identical. In describing the exemplary embodiments of the present invention, based on the case in which the bases are arranged such that the surfaces each with the intagliated pattern formed thereon face each other, the intagliated patterns formed on the different bases will be referred to as a first micro-pattern or a second micro-pattern in the same manner. However, as mentioned above, of course, according to a conceptual arrangement of bases, the intagliated patterns formed on the surfaces of two bases combined to form a micro-channel may have a mirror-symmetrical structure.

Similarly, a second intagliated micro-pattern 520 may be formed on each of the surfaces of the third base 300 and the fourth base 400 facing each other, and as the third base 300 and the fourth base 400 are laminated and combined, the second micro-pattern 520 on the surface of the third base 300 and the second micro-pattern 520 on the surface of the fourth base 400 may be combined to form a micro-structure including a second micro-channel 210. Here, a stationary phase coating layer (not shown) may be formed in a region forming the second micro-channel 210 with the second micro-pattern 520 on the surface of the third base 300 and the second micro-pattern 520 on the surface of the fourth base 400.

The analysis solution inlet 130 through which an analysis solution including an analysis target is introduced and the derivative inlet 140 through which a derivative including a derivative material is introduced may be a through hole penetrating through the first base 100, respectively. Here, of course, a through hole may be formed in one end of a guide channel 120 not connected to the first micro-channel 110, respectively. Of course, the first outlet 150 may be a through hole of the second base 200, and of course, the through hole as the first outlet 150 may be formed in one end of the first micro-channel not connected to the guide channel 120. A gas phase inlet 220 may be a through hole penetrating through the third base 300. As the through hole as the gas phase inlet 220 and the through hole as the first outlet communicate, the gas phase inlet 220 and the first outlet may communicate. A second outlet 230 may be a through hole of the fourth base 400 or may be a through hole penetrating through all of the third base 300, the second base 200, and the first base 100.

As in the example described above with reference to FIG. 1, since the chip body is formed by simply laminating and combining the bases having the intagliated micro-patterns formed on the surfaces thereof, the derivatization reaction gas chromatographic chip according to an exemplary embodiment of the present invention can be easily and simply manufactured and may be manufactured as a significantly compact micro-chip.

Also, since the first micro-channel 110 region in which the derivatization reaction is made and the second micro-channel 210 region in which a reaction occurs between mobile phases of a stationary phase and a gas phase are formed as the bases are simply laminated and combined, a stationary phase may be formed on an inner wall of the second micro-channel 210 by simply coating a stationary phase on the second micro-pattern 520 during the process and various types of stationary phases may be easily formed in different regions of the second micro-channel 210. Also, a physical size or shape of the micro-channels may be easily adjusted by controlling a size and a shape of the micro-patterns, and a length of the micro-channels may be easily controlled by changing a pattern of the micro-patterns.

Also, since the micro-channel structure is formed by combining the bases having the intagliated micro-patterns formed on surfaces thereof, the second micro-channel in which a stationary phase and a mobile phase are reacted may be freely elongated by increasing the number of bases having intagliated micro-patterns formed thereon laminated below the fourth base. Here, as the micro-patterns on the two surfaces of the bases forming the elongated second micro-channel in contact are combined in a manner similar to that as described above, the elongated second micro-channel may be formed.

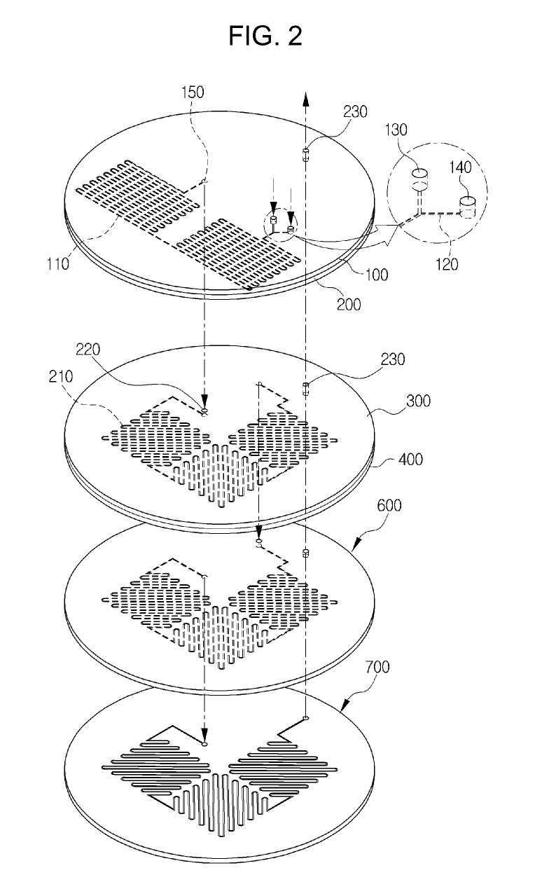

In detail, as in the example illustrated in FIG. 2, the second outlet 230 may be a through hole penetrating through the fourth base 400, and the fourth base 400 may have an intagliated micro-pattern formed on a surface opposing a surface thereof in contact with the third base 300. The fourth base 400 as an upper base, one or more internal bases 600 each having a micro-pattern formed on both surfaces thereof, and a single lower base 700 having an intagliated micro-pattern formed on a surface thereof in contact with the internal base 600 are sequentially laminated, and through holes may be formed in the internal bases 600 and the lower base 700, respectively, such that the micro-channel (the elongated second micro-channel) formed as the two bases in contact are combined communicate. In detail, through holes formed in the bases including the internal bases 600 and the lower base 700 may be formed in one of both ends of the intagliated micro-pattern formed on the surfaces of the bases to serve as an inlet, a connector, or an outlet. Here, the base having a through hole formed at a start point of the micro-pattern and the base having a through hole formed at an end point of the micro-pattern may be alternatively laminated to allow the second micro-channels to communicate. In addition, the second micro-channels may be elongated by combining two bases in contact, and in this case, different stationary phases may be formed by pairs of bases in contact.

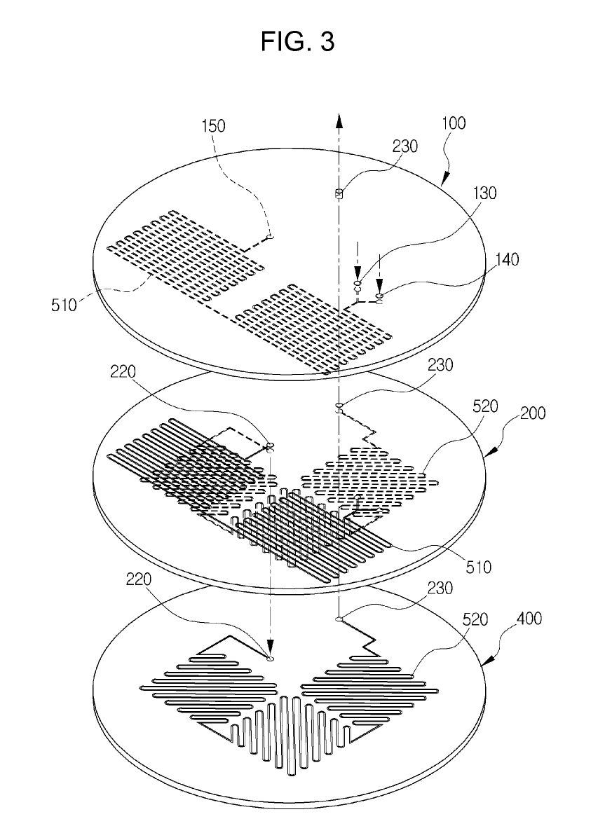

FIG. 3 is an exploded perspective view illustrating another example of a chip body of a derivatization reaction gas chromatographic chip according to an exemplary embodiment of the present invention. FIG. 1 shows a case in which the first micro-channel 110 is formed as the first base 100 and the second base 200 are combined and the second micro-channel 210 is formed as the third base 300 and the fourth base 400 are combined. Similar to the case of FIG. 1, FIG. 3 shows a case in which a first micro-pattern 510 is formed on one surface of the second base 200 and a second micro-pattern 520 is formed on the other surface thereof and a second micro-channel 210 is formed as the second base 200 and the fourth base 400 are combined. Here, of course, the first outlet 150 and the gas phase inlet 220 may be through holes of the second base 200 equally.

Hereinafter, examples of the derivatization reaction gas chromatographic chip according to exemplary embodiments of the present invention will be described on the basis of a structure of forming a chip body by laminating and combining the first base 100, the second base 200, the third base 300, and the fourth base 400 according to the example illustrated in FIG. 1. However, of course, like the example illustrated in FIG. 3, all of the examples described hereinafter will be applied in the same manner even to a case in which a chip body is formed by laminating and combining the first base 100, the second base 200, and the fourth base 400. Also, for the purpose of clarification, in the chip body, a region in which the first base 100 and the second base 200 are combined will be referred to as a derivative region, and a region in which the third base 300 and the fourth base 400 are combined will be referred to as a GC region.

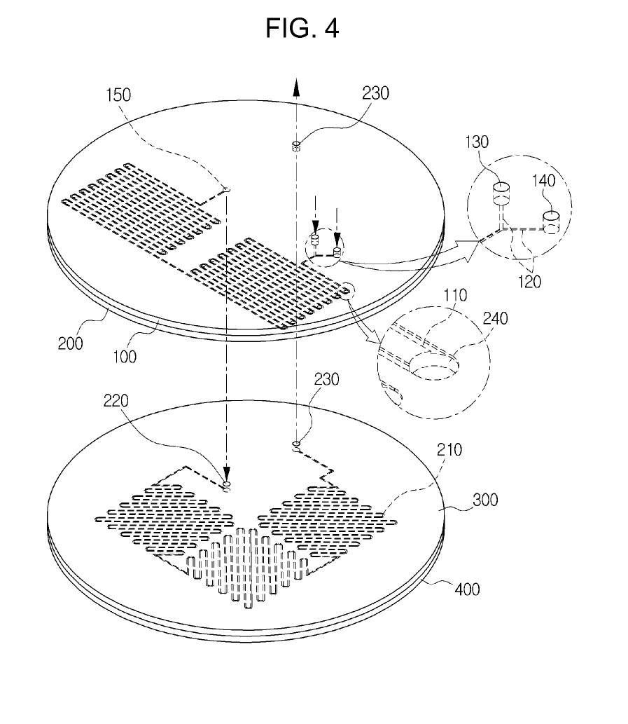

FIG. 4 is a transmission perspective view illustrating an example of a derivative region in the derivatization reaction gas chromatographic chip according to an exemplary embodiment of the present invention.

As illustrated in FIG. 4, one or more reactive regions 240 may be formed in the derivative region. The one or more reactive regions 240 have a cross-sectional area greater than that of the first micro-channel 110 in a flow path of the first micro-channel 110 to form a flow velocity lower than that of a fluid in the first micro-channel 110. A reflux for a smooth reaction between the analysis target material and the derivative material may be formed by the one or more reactive region 240.

In detail, the analysis solution containing the analysis target material introduced through the analysis solution inlet 130 and the derivative material, preferably, the reaction solution containing the derivative material, introduced through the derivative inlet 140 may be introduced to the first micro-channel 110 through each guide channel 120. The analysis solution and the reaction solution may be mixed and move through the first micro-channel 110, and here, the reactive regions 240 may serve to provide a location in which the derivative material of the reaction solution and the analysis target material may chemically react with one another more smoothly. Namely, the analysis solution and the reaction solution mixed and moving through the first micro-channel 110 may be refluxed from the reactive regions 240 as voids having a cross-sectional area greater than that of the first micro-channel 110 to cause a smooth chemical reaction between the derivative material and the analysis target material. As in the example illustrated in FIG. 4, two or more reactive regions 240 may be formed to be spaced apart from one another in the first micro-channel 110, and here, the two or more reactive regions 240 may be arranged to be spaced apart from one another regularly. Here, in terms of a manufacturing method, of course, the first micro-pattern 510 formed on the surfaces of the first base 100 and the second base 200 may have a shape corresponding to the previously designed first micro-channel 110 and the previously designed reactive regions 240, and the reactive regions 240 may be formed together with the first micro-channel 110 as the first base 100 and the second base 200 are laminated and combined.

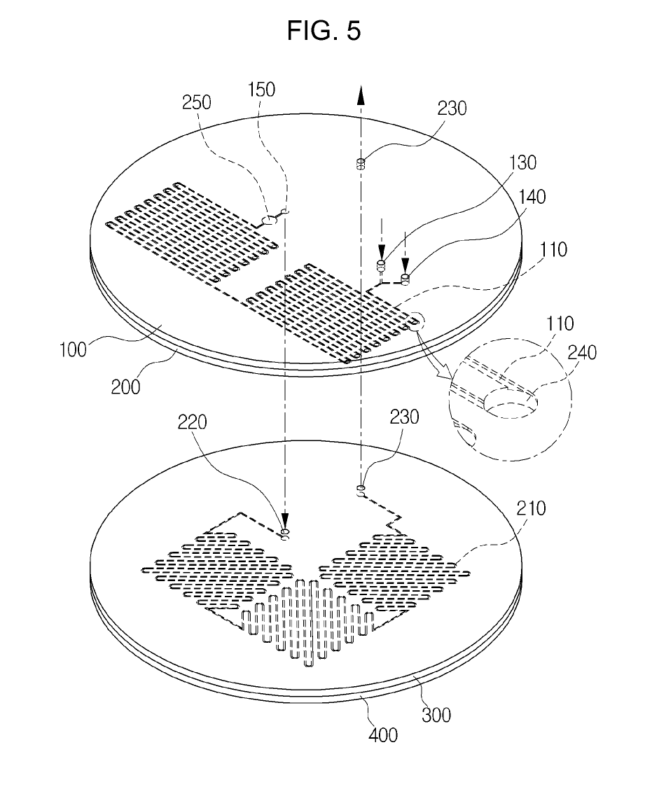

FIG. 5 is a transmission perspective view illustrating another example of a derivative region in the derivatization reaction gas chromatographic chip according to an exemplary embodiment of the present invention.

As in the example illustrated in FIG. 5, a dry region 250 for removing a liquid phase contained in the fluid discharged to the first outlet 150 may be further formed in the other end of the first micro-channel 110 in contact with the first outlet 150 in the derivative region. As the analysis solution and the reaction solution pass through the first micro-channel 110, a derivatized gas phase of the analysis target and a residual liquid phase may be formed. The dry region 250 may serve to remove the residual liquid phase. In detail, the dry region may include an adsorption reaction material which physically adsorbs the residual liquid phase to remove it and/or which chemically reacts with the residual liquid phase to remove it. In a non-limited example, the dry region 250 may be a void having a cross-sectional area greater than that of the first micro-channel 110 and may be a void in which an adsorption reactant is coated or adsorption reactant particles are supported. In a modification, the first base or the second base material itself may be an adsorption reactant itself or may contain an adsorption reactant, and in this case, the void itself having a cross-sectional area greater than that of the first micro-channel 110 may form the dry region. In consideration of a liquid phase introduced through the derivative inlet and a liquid material introduced through the analysis solution inlet, the adsorption reactant may be a material that may adsorb such a liquid material to remove it or chemically react with the liquid material to remove it. In a non-limited example, the adsorption reactant may be one or more selected from metal salt including magnesium sulfate, saccharide including sucrose, and an oxide including silica, silica gel, and alumina. As mentioned above, the adsorption reactant may have coated on a surface of the void providing the dry region or may have a particulate shape. In the case in which the adsorption reactant has a particulate shape, the particles may have fine pores and a residual solution may be physically removed by osmotic pressure through the fine pores. As mentioned above, since only the derivatized gaseous analysis target generated in the first micro-channel 110 is selectively introduced to the second micro-channel 210 by the dry region 250, sensitivity, accuracy, and reliability of the analysis can be further enhanced.

Here, in terms of the manufacturing method, of course, the second micro-pattern 520 formed on the surfaces of the third base 300 and the fourth base 400 may have a shape corresponding to the previously designed second micro-channel 210 and the previously designed dry region 250, and also, of course, the dry region 250 may be formed together with the first micro-channel 110 by laminating and combining the first base 100 and the second base 200. In the example illustrated in FIG. 5, the structure in which the dry region and the reactive region 240 are formed together with the first micro-channel 110 is illustrated, but, of course, only the dry region 250 may be formed without the reactive region 240.

As described above, in the derivatization reaction gas chromatographic chip according to the exemplary embodiment of the present invention, since the volatile derivatized analysis target is generated according to the reaction between the analysis target and the derivative material, the gaseous derivatized analysis target may be formed only by injecting the analysis solution and the reaction solution. In this case, however, in order to enhance efficiency of the derivatization reaction and increase a vaporization rate of the derivatized analysis target, thermal energy, optical energy, or vibrational energy may be applied to the first micro-channel 110. Namely, the derivatization reaction gas chromatographic chip according to the exemplary embodiment of the present invention may further include an energy applying member that applies thermal energy, optical energy, or vibrational energy to the first micro-channel 110. In this case, optical energy may include infrared light or near-infrared light, and vibrational energy may include microwave. The energy applying member may be physically separated from the chip body or may be integrally provided with the chip body. For example, in a case in which energy applied to the first micro-channel 110 is thermal energy, a heat source including a thermoelectric element or a heating element generating Joule's heat may be integrally attached to the chip body, and in a case in which applied energy is vibrational energy or optical energy, a vibration generating source or a light source may be provided to be separated from the chip body and vibration (including microwaves) generated by the vibration generating source or light may be applied to the first micro-channel 110 through a free space. In this case, of course, the derivatization reaction gas chromatographic chip according to an exemplary embodiment of the present invention may further include a general controller that may adjust a magnitude (e.g., Watt, power, a quantity of light, and a quantity of heat) of applied energy, together with the energy applying member. In a case in which energy needs to be precisely controlled according to an analysis target material and/or a derivative material, a general measurement unit such as a thermocoupler may be further provided to be attached to the chip body for control feedback. Also, of course, the energy applying member and/or the measurement unit may be provided to be attached to a base region in which a micro-pattern is not formed.

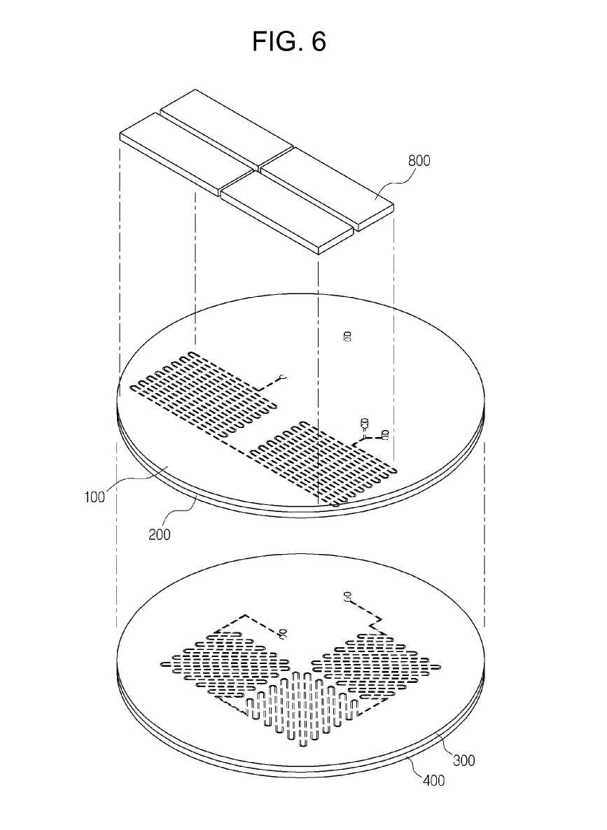

Due to the material specificity of the analysis target material and the derivative material, a predetermined reaction temperature may be required for a smooth reaction, and in order to entirely vaporize the derivatized analysis target material, energy applied to the first micro-channel 110 is preferably thermal energy. In a specific example, a temperature of the first micro-channel 110 may range from 50° C. to 250° C. by the energy applying member. FIG. 6 is a perspective view illustrating the chip body of the derivatization reaction gas chromatographic chip according to an exemplary embodiment of the present invention when thermal energy is applied to the first micro-channel 110. As in the example illustrated in FIG. 6, the energy applying member may include a thermoelectric element 800. The thermoelectric element 800 may allow for precise controlling of a temperature of the first micro-channel 110 without marring a reduction in size of the derivatization reaction gas chromatographic chip. The thermoelectric element 800 may be positioned on an upper surface of the first base 100 as in the example illustrated in FIG. 6. In the case in which the thermoelectric element 800 is positioned on the upper surface of the first base 100, temperature uniformity of the first micro-channel 110 may be enhanced and influence thereof on the second micro-channel 210 may be minimized.

The chip body may further include a heat transmission member that may adjust a temperature of the second micro-channel 210, independent from the energy applying member applying energy to the first micro-channel 110. One or two or more of a general heating element generating Joule's heat, a thermoelectric element, and a general cooling unit cooling the surroundings by a coolant may be selected as the heat transmission member. The heat transmission member may be attached to the chip body, and in this case, the heat transmission member may be attached to a position in which a temperature of the second micro-channel may be uniformly adjusted. In a non-limited example, the heat transmission member may be provided to be attached to a surface of the fourth base opposing the surface thereof in contact with the third base, namely, to a lower surface of the fourth base. Here, the foregoing controller may control the heat transmission member in the energy applying member, or a controller independently controlling the heat transmission member may be provided. Also, of course, a general measurement unit such as a thermocouple may be further provided to be attached to the chip body for the purpose of control feedback.

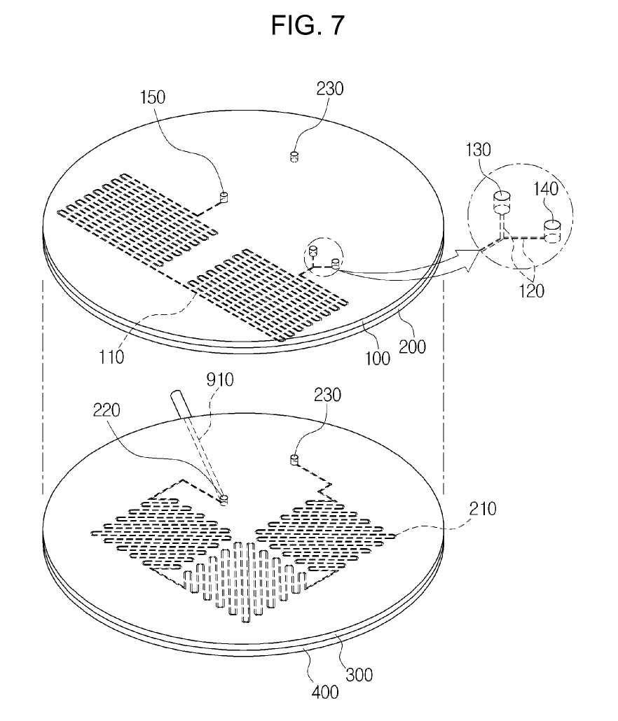

The derivatization reaction gas chromatographic chip according to the exemplary embodiment of the present invention may further include a modulator formed in the gas phase inlet. Preferably, the modulator may communicate with the gas phase inlet to intermittently supply alternately a cooled inert gas and a heated inert gas to the gas phase inlet. Thus, cryogenic traps and heat pulses may be alternately formed in the inlet through which a gas phase is introduced to the GC region by the modulator. As mentioned above, since the modulator is implemented by simply supplying a gas, the modulator may stably enhance separability without marring a reduction in size of the analyzing device. The modulator may be implemented by forming a gas supply port communicating with the gas phase inlet, without ruining a movement path in which a fluid moves within the chip body. As in an example illustrated in FIG. 7, when a lamination direction of the first base 100, the second base 200, the third base 300, and the fourth base 400 is considered a height direction (or may be considered a thickness direction of the bases) and surfaces of the bases parallel to the height direction are considered lateral surfaces, a gas feeding inlet 910 may be formed on the lateral surfaces of the second base 200 to the third base 300. In detail, as illustrated in FIG. 7(a), the first outlet 150 and the gas phase inlet 220 communicate, and here, a through hole may be formed on the lateral surface of the second base 200 to communicate with the first outlet of the second base 200, thus forming the gas feeding inlet 910, or as illustrated in FIG. 7(b), a through hole may be formed on the lateral surface of the third base 300 to communicate with the gas phase inlet 220 of the third base 300, thus forming the gas feeding inlet 910. Alternatively, as illustrated in FIG. 7(c), one or two or more through holes may be formed on both of the lateral surface of the second base 200 and the lateral surface of the third base 300 to communicate with the first outlet 150 and the gas phase inlet 220, thus forming the gas feeding inlet 910. Of course, in this case, separated from the chip body, an inert gas storage source, a gas controller that may adjust supply and a velocity of flow of an inert gas, a tube that may provide a gas movement path of the inert gas storage source and the gas feeding inlet, and a general temperature adjusting member that may heat and/or cool a helium gas between the inert gas storage source and the tube may further be provided. Also, the inert gas itself stored in the inert gas storage source may be in a cooled state, and, of course, a temperature adjusting member (heater, a flame, or the like) that may heat the helium gas between the inert gas storage source and the tube may further be provided.

As described above with reference to FIG. 7, as for the derivatized analysis target (gas phase) moving from the derivative region to the GC region, whether to supply the derivatized analysis target and/or a supply velocity (whether to supply the derivatized analysis target to the GC region and/or a supply velocity of the derivatized analysis target to the GC region) may be controlled by the modulator. When a very low temperature effect is applied to the gas mixture including the derivatized analysis target introduced to the GC region, a movement time of the gas mixture may be lengthened and an analysis time is lengthened, and thus, separability can be remarkably enhanced enough to analyze a trace of the analysis target. Also, since cryogenic cold traps are formed according to supply of the cooled inert gas, the gas mixture in a mobile phase may be secondarily separated and a retention time in the GC region may be arbitrarily adjusted. In addition, when the gas mixture (including the derivatized analysis target) in a mobile phase is introduced to and move in the GC region, if the gas mixture is secondarily separated, a separation peak of the gas mixture may be refocused.

As described above, the modulator may intermittently condense the gas mixture introduced to the GC region and give a heat pulse again thereto to allow for a secondary analysis. Obviously, a material of the inert gas, a temperature of the cooled inert gas, a temperature of the heated inert gas, a supply time of the inert gas, a time interval at which the cooled inert gas and the heated inert gas are alternately supplied, and the like, may be appropriately designed in consideration of the characteristics of a material to be analyzed and on the basis of general knowledge and experience of a person skilled in the art. In a non-limited example, an inert gas may be maintained in a stable gas phase in a cooled or heated state such that it does not chemically react with an analysis target material (including a derivatized analysis target material) and forms cryogenic traps and heat pulses. In a specific example, the inert gas may be helium, nitrogen, argon, or the like. A cooling temperature of the inert gas may be appropriately designed in consideration of characteristics and/or analysis sensitivity of a material intended to be analyzed, and specifically, it may range from −210° C. to −10° C. Also, a heating temperature of the inert gas may be appropriately designed in consideration of characteristics and/or analysis sensitivity of a material intended to be analyzed, and specifically, it may range from 100° C. to 39° ° C.

In the derivatization reaction gas chromatographic chip according to the exemplary embodiment of the present invention, since the stationary phase coating layer is formed on the entire surfaces of the third and fourth bases with the second micro-pattern intagliated thereon, the faying surfaces of the third and fourth bases may be hermetically coupled by the stationary phase coating layer.

As described above with reference to FIG. 1, in the derivatization reaction gas chromatographic chip according to the exemplary embodiment of the present invention, the micro-flow path structure such as the first micro-channel, the reactive region, the dry region, and the second micro-channel may be fabricated by laminating and combining the bases with the micro-patterns intagliated to have a shape and a size corresponding to the shape of the designed micro-channels and the reactive region or the dry region of the chip body.

Thus, the stationary phase coating layer may be formed within the micro-channels by simply coating the stationary phase on the base surfaces constituting the GC region, before combining the bases. In this case, the stationary phase coating layer may also be formed in a region other than the surface regions of the bases with the micro-patterns intagliated thereon, such a stationary phase coating layer may serve as a sealant hermetically combining the bases forming the GC region. In addition, since the surfaces of the bases before being combined are macroscopically flat surfaces, the stationary phase coating layer may be formed by using a simple spin coating method. The bases constituting the derivatization region may also be easily combined by using a method of applying a material having a resin with hardenability dissolved therein to the surfaces of the bases before being combined, combining the bases, and curing the resin, and by virtue of the resin with hardenability, the micro-channels may be sealed. In this case, the resin with hardenability may be a general resin that may be thermally set or UV-cured, and may be a resin which is chemically stable with respect to a material injected into the micro-channels or the derivatized analysis target material produced in the micro-channels. Of course, however, the bases may be combined and sealed through hot pressing, anodic bonding, or the like, without the aid of a settlement and sealing material.

Also, since the chip body is formed by laminating and combining the bases with the micro-patterns intagliated thereon, the micro-patterns designed on each of the bases may be intagliated through a general photolithography process using a photo mask having micro-patterns corresponding to the micro-patterns desired to be intagliated and photoresist and a wet etching process using exposed and developed photoresist as an etching mask. Wet etching is advantageous in that an implementation device and process are simple and it may be performed within a short time at low cost, relative to dry etching. Also, when the micro-patterns are formed through wet etching as mentioned above, cross-sections of the micro-patterns may have a hemispherical shape. Thus, micro-channels having circular or oval cross-sections may be fabricated by combining two bases. Such circular or oval cross-sections are desirable in the aspect of stably and uniformly transferring a fluid that move within the channels and may enhance analysis stability and reliability. In order for the reactive region or dry region to have a cross-section greater than that of the micro-channels, micro-pattern regions corresponding to the reactive region or the dry region need to be etched to be deeper than the micro-pattern region corresponding to the micro-channels. To this end, after wet etching performed to form the micro-channels, an etching mask exposing only the micro-pattern regions corresponding to the reactive region or the dry region may be formed by using photoresist and a photo mask again, and wet etching may be subsequently performed again. Wet etching for the formation of the micro-channels or wet etching for the formation of the reactive region or the dry region may be performed once or more independently. Specifically, wet etching may be repeatedly performed one to five times.

In the derivatization reaction gas chromatographic chip according to the exemplary embodiment of the present invention, each base material constituting the laminate body may be a material chemically stable with respect to a material injected into the micro-channels and the derivatized analysis target material generated in the micro-channels and may be a material having light transmittance such that materials separated by the stationary phase in the second micro-channel may be optically analyzed. In a specific example, one or two or more selected from among polymethylsiloxane, polydimethylsiloxane, glass, quartz, silicon, silicate, borosilicate, and molten silicate, independently, may be used as materials of the bases constituting the laminate body.

In the derivatization reaction gas chromatographic chip according to the exemplary embodiment of the present invention, the analysis target material contained in the analysis solution may be any material analyzed through general chromatography, such as a polymer, an inorganic compound, an organic compound, an organic-inorganic compound, a biochemical material, bio-extracts, and the like, and a material having low volatility may also be used due to the advantages of the present invention. In this case, a liquid phase of the analysis solution may be an analysis target material itself, or may be a solvent or a dispersion medium that dissolves or disperses the analysis target material. In this case, of course, an appropriate solvent or dispersion medium may be selected according to general knowledge and experience of a person skilled in the art.

In the derivatization reaction gas chromatographic chip according to the exemplary embodiment of the present invention, any material may be used as the derivative material as long as it is generally reacted chemically with a material having low volatility to enhance volatility of the analysis target material. For example, the derivative material may be a material for alkylating, silylating, acrylating, acetylating, or esterifying the analysis target material. In detail, when the analysis target material has a function group (—COOH, —OH, —NH, —SH, etc.) of active hydrogen, the derivative material may be a material that may weaken the hydrogen bond to easily vaporize it. In consideration of the analysis target material, a generally known material used to alkylate, silylate, acrylate, acetylate, or esterify the analysis target material in the chromatography field may be used. The liquid phase of the reaction solution may be a derivative material itself or may be a solvent dissolving the derivative material.

In the derivatization reaction gas chromatographic chip according to an exemplary embodiment of the present invention, any material used as a stationary phase in an analysis column of general gas chromatography may be used as the stationary phase formed in the second micro-channel (including the elongated second micro-channel). In a specific example, the material may include polydimethylsiloxane, polyethylglycol, silica, silica gel, alumina, charcoal, molecular sieve, a porous polymer, and the like, but, of course, the present inventive concept is not limited to the stationary phase material.

In this case, the base material forming the GC region may be a stationary phase material itself, and thus, in a case in which a stationary phase is desired to be formed with a base material, an independent stationary phase coating layer may not be provided. Also, of course, in a case in which a different stationary phase providing different polarity is desired to be formed in a fluid flow direction of the second micro-channel (including the elongated second micro-channel), although the base material is a stationary phase material, a stationary phase coating layer different from the base material may be provided in a predetermined channel region.

In the derivatization reaction gas chromatographic chip according to an exemplary embodiment of the present invention, the respective bases constituting the derivatization region and the GC region may have the same size or different sizes macroscopically, and the bases may have any thickness as long as physical stability of the chip body is not marred. An area of the bases may be appropriately changed according to a length of the micro-channels. A length of the first micro-channel of the derivatization region, a size of the reaction regions, and an amount of the reaction regions may be appropriately designed in consideration of a smooth derivatization reaction and vaporization of the derivatized analysis target. Also, a length of the second micro-channel may be appropriately designed in consideration of separation of the derivatized analysis target by the stationary phase.

A diameter of the micro-channels including the first and second micro-channels and a size of the through holes of the respective bases may be a general diameter or size used in a general micro-fluidics chip. In a case in which a micro-channel has a very small diameter, an analysis solution may be analyzed although it is applied with a minimum quantity. In order to allow a minimum quantity of sample to be analyzed and enhance accuracy of chromatography analysis, the first micro-channel and the second micro-channel may have a diameter ranging from 10 μm to 500 μm, independently. Also, a size of the through holes of the respective bases may be greater than or equal to the diameter of the micro-channels. Specifically, the through holes may have a diameter equal to 1 to 10 times the diameter of the micro-channels to which the through holes are connected. In a case in which diameters of the analysis solution inlet 130 and the derivative inlet 140 are greater than that of the first micro-channel, a guide channel may have a shape tapered to be gradually narrowed in a direction toward the first micro-channel from the analysis solution inlet 130 or the derivative inlet 140.

The reactive region may have a size sufficient for reflux. In a specific example, the reactive region may have a diameter equal to 2 to 50 times the diameter of the first micro-channel. The dry region may have a size sufficient to smoothly remove a residual liquid phase. In a specific example, the dry region may have a diameter equal to 2 to 50 times the diameter of the first micro-channel. Here, as mentioned above, in the case in which the reactive region and the dry region is formed through wet etching, the reactive region or the dry region may have a circular or oval cross-section similar to that of the micro-channels.

In the derivatization reaction gas chromatographic chip according to an exemplary embodiment of the present invention, of course, an appropriate connector (for example, Nanoport Assembly® manufactured by Upchurch Scientific. U.S.A.) may be connected to the gas feeding inlet, the analysis solution inlet, the derivative inlet, and the outlet through which a fluid is finally discharged from the chip body, and of course, the foregoing derivatization reaction gas chromatographic chip may be used together with a detector such as an electron capture detector.

The derivatization reaction gas chromatographic chip according to the present invention can separate materials by components based on a derivatization reaction and differences in adsorbability or partition coefficients between a gas phase and a mobile phase within the single chip through a single step of simply injecting the analysis target material and the derivative material, can be reduced to have a very small size, can analyze even when a minimum quantity of analysis solution is applied thereto, and can make an analysis within a short time at low cost. In addition, since the derivatization reaction is performed within the chip body, an experimental error that may be caused by the derivatization reaction can be minimized, ensuring a more reproducible analysis.

Hereinabove, although the present invention is described by specific matters, exemplary embodiments, and drawings, they are provided only for assisting in the entire understanding of the present invention. Therefore, the present invention is not limited to the exemplary embodiments. Various modifications and changes may be made by those skilled in the art to which the present invention pertains from this description.

Therefore, the spirit of the present invention should not be limited to the above-described embodiments, and the following claims as well as all modified equally or equivalently to the claims are intended to fall within the scope and spirit of the invention.

What is claimed is:

1. A derivatization reaction gas chromatographic chip comprising:
an analysis solution inlet allowing an analysis solution containing an analysis target to be introduced therethrough;
a derivative inlet allowing a reaction solution containing a derivative chemically reacting with the analysis target to be introduced therethrough;
a guide channel connecting one end of a first micro-channel to each of the analysis solution inlet and the derivative inlet;
the first micro-channel in which a fluid introduced through the analysis solution inlet and the derivative inlet flows and the analysis target in the fluid reacting with the derivative is vaporized;
a first outlet connected to the other end of the first micro-channel; a gas phase inlet communicating with the first outlet;
a second micro-channel having one end connected to the gas phase inlet and having a stationary phase formed therein; and
a second outlet connected to the other end of the second micro-channel,
wherein the analysis target contained in the analysis solution is vaporized and the vaporized analysis target is separated by the stationary phase by the single chip body.

2. The derivatization reaction gas chromatographic chip of claim 1, wherein
the guide channel and the first micro-channel are formed as a first base and a second base each having a first micro-pattern intagliated on a surface thereof are laminated and combined,
the second micro-channel is formed as a third base and a fourth base each having a second micro-pattern intagliated on a surface thereof are laminated and combined,
the analysis solution inlet and the derivative inlet are through holes penetrating through the first base, respectively,
the first outlet and the gas phase inlet that communicate with one another are a through hole of the second base and a through hole of the third base, respectively, that communicate with one another,
the second outlet is a through hole that penetrates through the fourth base or all of the third base, the second base, and the first base, and
the chip body comprises a laminate body formed by laminating and combining the first base, the second base, the third base, and the fourth base.

3. The derivatization reaction gas chromatographic chip of claim 1, wherein one or more reactive regions having a cross-section greater than that of the first micro-channel to form a velocity of flow lower than that of a fluid in the first micro-channel are formed on a flow path of the first micro-channel.

4. The derivatization reaction gas chromatographic chip of claim 1, wherein thermal energy, optical energy, or vibrational energy is applied to the first micro-channel.

5. The derivatization reaction gas chromatographic chip of claim 2, further comprising a thermoelectric element applying thermal energy to the first micro-channel.

6. The derivatization reaction gas chromatographic chip of claim 1, wherein a dry region for removing a liquid phase contained in the fluid discharged through the first outlet is further formed in the other end of the first micro-channel in contact with the first outlet.

7. The derivatization reaction gas chromatographic chip of claim 2, further comprising a modulator formed in the gas phase inlet side.

8. The derivatization reaction gas chromatographic chip of claim 7, wherein the modulator communicates with the gas phase inlet to intermittently alternately supply a cooled inert gas and a heated inert gas to the gas phase inlet to alternately generate cryogenic traps and heat pulses.

9. The derivatization reaction gas chromatographic chip of claim 2, wherein the second micro-channel is elongated as the amount of bases having the micro-patterns intagliated thereon and laminated below the fourth base is increased, and the elongated second micro-channel is formed as the micro-patterns on the two surfaces of the bases forming the elongated second micro-channel in contact are combined.

10. The derivatization reaction gas chromatographic chip of claim 6, wherein the second micro-channel has two or more different stationary phases formed in different regions thereof.

11. The derivatization reaction gas chromatographic chip of claim 2, wherein a stationary phase coating layer is formed on the entire surfaces of the third base and the fourth base each having the second micro-pattern intagliated thereon, and faying surfaces of the third base and the fourth base are hermetically combined by the stationary phase coating layer.

12. The derivatization reaction gas chromatographic chip of claim 2, wherein each of the base materials constituting the laminate body is one or two or more selected from among polymethylsiloxane, polydimethylsiloxane, glass, quartz, silicon, silicate, borosilicate, and molten silicate, independently.

13. The derivatization reaction gas chromatographic chip of claim 2, wherein the micro-patterns of the respective bases constituting the laminate body are formed through wet etching.

14. The derivatization reaction gas chromatographic chip of claim 2, wherein one or more reactive regions having a cross-section greater than that of the first micro-channel to form a velocity of flow lower than that of a fluid in the first micro-channel are formed on a flow path of the first micro-channel.

15. The derivatization reaction gas chromatographic chip of claim 2, wherein a dry region for removing a liquid phase contained in the fluid discharged through the first outlet is further formed in the other end of the first micro-channel in contact with the first outlet.

16. The derivatization reaction gas chromatographic chip of claim 15, wherein the second micro-channel has two or more different stationary phases formed in different regions thereof.
